(19) United States
(12) Patent Application Publication
(10) Pub. No.: US 2007/0265021 A1
(43) Pub. Date: Nov. 15, 2007

(54) ROAMING CONTROL DEVICE, MOBILE COMMUNICATION TERMINAL, MOBILE COMMUNICATION SYSTEM, AND ROAMING CONTROL METHOD

(75) Inventors: Yoshio Igaue, Yokosuka-shi (JP); Takashi Tosaki, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: NTT DoCoMo, Inc., Chiyoda-ku (JP)

(21) Appl. No.: 11/746,916

(22) Filed: May 10, 2007

(30) Foreign Application Priority Data
May 11, 2006 (JP) 2006-132875

(51) Int. Cl. H04Q 7/20

(52) U.S. Cl. 455/461

(57) ABSTRACT

The present invention allows a mobile communication terminal to easily and reliably visit a roaming network that conforms to user requirements during roaming. The HLR comprises a roaming network information database for storing information relating to the roaming networks that are mobile communication network which the mobile communication terminal is able to visit during roaming; a network information reception section for receiving information specifying a plurality of roaming networks that can be visited by the mobile communication terminal; a requirement acquisition section for acquiring information on the requirements with respect to the roaming networks of the user; a priority level determination section for determining the priority level with which the mobile communication terminal is to visit the plurality of roaming networks by referencing information relating to the roaming networks on the basis of the requirements; and a priority level information transmission section for transmitting information on the priority level thus determined to the mobile communication terminal.

### BACKGROUND OF THE INVENTION

1. Field of the Invention

The present invention relates to a roaming control device for controlling the roaming of a mobile communication terminal, the mobile communication terminal, a mobile communication system that is constituted comprising the roaming control device and the mobile communication terminal, and a roaming control method.

2. Related Background of the Invention

Roaming involves an attempt to receive the services of a service provider with whom the user has a contract by using a mobile communication network (called the ‘roaming network’ hereinbelow) of a service provider (supporting roaming) other than the service provider with whom the user has a contract even when the mobile communication terminal is outside the service provision area of the service provider with whom the user has a contract. More specifically, the mobile communication terminal is able to connect to the mobile communication network of the service provider with whom the user has a contract (called the ‘home network’ hereinbelow) via a roaming network by visiting (connecting to) the roaming network.

Conventionally, in cases where there are a plurality of roaming networks that the mobile communication terminal is able to visit, there are generally two different methods for selecting the visited roaming network, namely, auto-search in which the mobile communication terminal automatically selects a visited network and manual search, in which a visited network is selected manually by the user. Auto-search is a function whereby the mobile communication terminal automatically selects a visited network in accordance with the priority levels that are prescribed by 3GPP (3rd Generation Partnership Project) standard specifications. Here, it is possible to input the roaming network that the user would like to prioritize for a visit ahead of time. The content above appears in Japanese Application Laid Open No. 2005-57158 which is a Japanese Patent Kokai publication. The information that is input is registered in a module such as a USIM (Universal Subscriber Identity Module) of a mobile communication terminal, for example. Manual search is a function whereby the mobile communication terminal detects roaming networks that can be visited, and the user is able to freely select a roaming network from among the detected roaming networks.

By using these two different kinds of selection methods, the user is able to select a roaming network that more conforms to the requirements of the user in terms of fees and services and so forth. In cases where the user would like to visit a roaming network with lower communication fees, for example, the user is able to select the roaming network by means of a manual search. Further, in cases where the user would like to use a TV phone using the home network which is the roaming destination, a roaming network that allows a TV phone to be used is registered beforehand as a high priority roaming network and a TV phone can be used even in the case of a roaming connection by performing an auto search.

### SUMMARY OF THE INVENTION

However, in the case of the above technology, in order to select a roaming network that more conforms to the needs of the user in terms of fees and services and so forth, it has been a requirement to examine the communication fees of and the services provided by the respective roaming networks beforehand. Further, the user is unrestricted in terms of being able to obtain, as the latest accurate information, the information required in order to select a roaming network that satisfies their requirements and, therefore, there are no restrictions on the user being able to set a suitable priority level.

The present invention was conceived in order to solve the above problem and an object thereof is to provide a roaming control device, a mobile communication terminal, a mobile communication system, and a roaming control method that make it possible for the mobile communication terminal to easily and reliably visit a roaming network that conforms to the requirements of the user during roaming.

In order to achieve the above object, the roaming control device according to the present invention comprises a roaming network information database for storing information relating to roaming networks that are mobile communication networks which a mobile communication terminal is able to visit during roaming; network information reception means for receiving information transmitted by the mobile communication terminal and specifying a plurality of roaming networks that can be visited by the mobile communication terminal; requirement acquisition means for acquiring information on the requirements of a user of the mobile communication terminal with respect to the roaming networks; priority level determination means for determining the priority level with which the mobile communication terminal is to visit the plurality of roaming networks specified by information that is received by the network information reception means by referencing information relating to the roaming networks stored in the roaming network information database on the basis of the requirements acquired by the requirement acquisition means; and priority level information transmission means for transmitting information on the priority level determined by the priority level determination means to the mobile communication terminal.

In order to achieve the above object, the mobile communication terminal of the present invention comprises detection means for detecting a plurality of roaming networks which are a plurality of mobile communication networks that can be visited during roaming; network information transmission means for transmitting information specifying the plurality of roaming networks detected by the detection means to a roaming control device; priority level information reception means for receiving information on the priority level with which its own terminal is to visit the plurality of roaming networks, that is transmitted by the roaming control device in response to the transmission of information specifying the plurality of roaming networks that is carried out by the network information transmission means; and network-visit processing means for performing processing to visit any of the plurality of roaming networks on the basis of information on the priority level for the plurality of roaming networks that is received by the priority level information reception means.

According to the present invention, the roaming control device determines the priority level with which the mobile communication terminal is to visit a plurality of roaming networks that can be visited and which have been detected by the mobile communication terminal on the basis of the user's requirements with respect to the roaming networks. The mobile communication terminal performs processing to visit any of the plurality of roaming networks on the basis of information on these priority levels. Therefore, according to the present invention, if the requirements with respect to the roaming networks are designated, the mobile communication terminal can be automatically made to visit the roaming network which conforms to these requirements. Further, as long as an attempt is made to always store the latest information in the roaming network information database of the roaming control device, it will be possible to reliably visit the roaming network which conforms to the requirements.

The requirement acquisition means desirably acquires information on the requirements by receiving same from the mobile communication terminal. The requirement acquisition means desirably performs acquisition from information on the requirements that is pre-registered. The mobile communication terminal desirably further comprises requirement transmission means for transmitting information on the requirements of a user with respect to the roaming networks, to the roaming control device. The requirement transmission means desirably transmits information on the requirements by including the information on the requirements in a position-registration-related signal that is transmitted by the mobile communication terminal. According to this constitution, information on the user's requirements can be reliably acquired by the roaming control device and the present invention can be reliably implemented.

Further, in addition to being described as the inventions of a roaming control device and mobile communication terminal as above, the present invention can also be described as the inventions of a mobile communication system and a roaming control method as will be detailed hereinbelow. These are substantially the same inventions, differing only with respect to the category or the like and yield the same action and effects.

In other words, the mobile communication system according to the present invention is a mobile communication system that is constituted having a roaming control device and a mobile communication terminal, wherein the roaming control device comprises: a roaming network information database for storing information relating to roaming networks that are mobile communication networks which the mobile communication terminal is able to visit during roaming; network information reception means for receiving information transmitted by the mobile communication terminal and specifying a plurality of roaming networks that can be visited by the mobile communication terminal; requirement acquisition means for acquiring information on the requirements of a user of the mobile communication terminal with respect to the roaming networks; priority level determination means for determining the priority level with which the mobile communication terminal is to visit the plurality of roaming networks specified by information that is received by the network information reception means by referencing information relating to the roaming networks stored in the roaming network information database on the basis of the requirements acquired by the requirement acquisition means; and priority level information transmission means for transmitting information on the priority level determined by the priority level determination means to the mobile communication terminal, and wherein the mobile communication terminal comprises: detection means for detecting the plurality of roaming networks; network information transmission means for transmitting information specifying the plurality of roaming networks detected by the detection means to the roaming control device; priority level information reception means for receiving information on the priority level with which its own terminal is to visit the plurality of roaming networks, that is transmitted by the roaming control device in response to the transmission of information specifying the plurality of roaming networks that is carried out by the network information transmission means; and network-visit processing means for performing processing to visit any of the plurality of roaming networks on the basis of information on the priority level for the plurality of roaming networks that is received by the priority level information reception means.

The roaming control method according to the present invention is a roaming control method for a roaming control device comprising a roaming network information database that stores information relating to roaming networks which are mobile communication networks that the mobile communication terminal is able to visit during roaming, comprising: a network information reception step of receiving information transmitted by the mobile communication terminal and specifying a plurality of roaming networks that can be visited by the mobile communication terminal; a requirement acquisition step of acquiring information on the requirements of a user of the mobile communication terminal with respect to the roaming networks; a priority level determination step of determining the priority level with which the mobile communication terminal is to visit the plurality of roaming networks specified by information that is received in the network information reception step by referencing information relating to the roaming networks stored in the roaming network information database on the basis of the requirements acquired in the requirement acquisition step; and a priority level information transmission step of transmitting information on the priority level determined in the priority level determination step to the mobile communication terminal.

The roaming control method according to the present invention is a roaming control method for a mobile communication terminal, comprising: a detection step of detecting a plurality of roaming networks which are a plurality of mobile communication networks that can be visited during roaming; a network information transmission step of transmitting information specifying the plurality of roaming networks detected in the detection step to a roaming control device; a priority level information reception step of receiving information on the priority level with which its own terminal is to visit the plurality of roaming networks, that is transmitted by the roaming control device in response to the transmission of information specifying the plurality of roaming networks that is carried out in the network information transmission step; and a network-visit processing step of performing processing to visit any of the plurality of roaming networks on the basis of information on the priority level for the plurality of roaming networks that is received in the priority level information reception step.

The roaming control method according to the present invention is a roaming control method for a mobile communication system constituted having a mobile communication terminal and a roaming control device, which has a roaming network information database that stores information relating to roaming networks which are mobile communication networks that the mobile communication terminal is able to visit during roaming, comprising steps in which the roaming control device performs: a network information reception step of receiving information transmitted by the mobile communication terminal and specifying a plurality of roaming networks that can be visited by the mobile communication terminal; a requirement acquisition step of acquiring information on the requirements of a user of the mobile communication terminal with respect to the roaming networks; a priority level determination step of determining the priority level with which the mobile communication terminal is to visit the plurality of roaming networks specified by information that is received in the network information reception step by referencing information relating to the roaming networks stored in the roaming network information database on the basis of the requirements acquired in the requirement acquisition step; and a priority level information transmission step of transmitting information on the priority level determined in the priority level determination step to the mobile communication terminal, and comprising steps in which the mobile communication terminal performs: a detection step of detecting the plurality of roaming networks; a network information transmission step of transmitting information specifying the plurality of roaming networks detected in the detection step to the roaming control device; a priority level information reception step of receiving information on the priority level with which its own terminal is to visit the plurality of roaming networks that is transmitted by the roaming control device in response to the transmission of information specifying the plurality of roaming networks that is carried out in the network information transmission step; and a network-visit processing step of performing processing to visit any of the plurality of roaming networks on the basis of information on the priority level for the plurality of roaming networks that is received in the priority level information reception step.

According to the present invention, the roaming control device determines the priority level with which the mobile communication terminal is to visit a plurality of roaming networks that can be visited and which have been detected by the mobile communication terminal on the basis of the requirements of a user with respect to the roaming networks and the mobile communication terminal performs processing to visit any of the plurality of roaming networks on the basis of the priority level information, whereby it is possible to easily and reliably visit the roaming network which conforms to user requirements.

### BRIEF DESCRIPTION OF THE DRAWINGS

FIG. 1 shows the constitution of a mobile communication system as well as an HLR and a mobile communication terminal that are contained in the mobile communication system according to an embodiment of the present invention;

FIG. 2 shows the hardware constitution of the HLR of the embodiment of the present invention;

FIG. 3 shows a table of a roaming network information database according to this embodiment;

FIG. 4 shows an example of information on the requirements with respect to roaming networks of the user of the mobile communication terminal according to this embodiment;

FIG. 5 shows the hardware constitution of the mobile communication terminal of the embodiment of the present invention; and

FIG. 6 is a sequence diagram showing processing (roaming control processing) that is executed by the mobile communication system (HLR and mobile communication terminal) of the embodiment of the present invention.

### DESCRIPTION OF THE PREFERRED EMBODIMENTS

Preferred embodiments of the roaming control device, mobile communication terminal, mobile communication system, and roaming control method of the present invention will be described in detail hereinbelow with reference to the drawings. The same symbols have been assigned to the same elements in the description of the drawings, whereby repetition is avoided in the description.

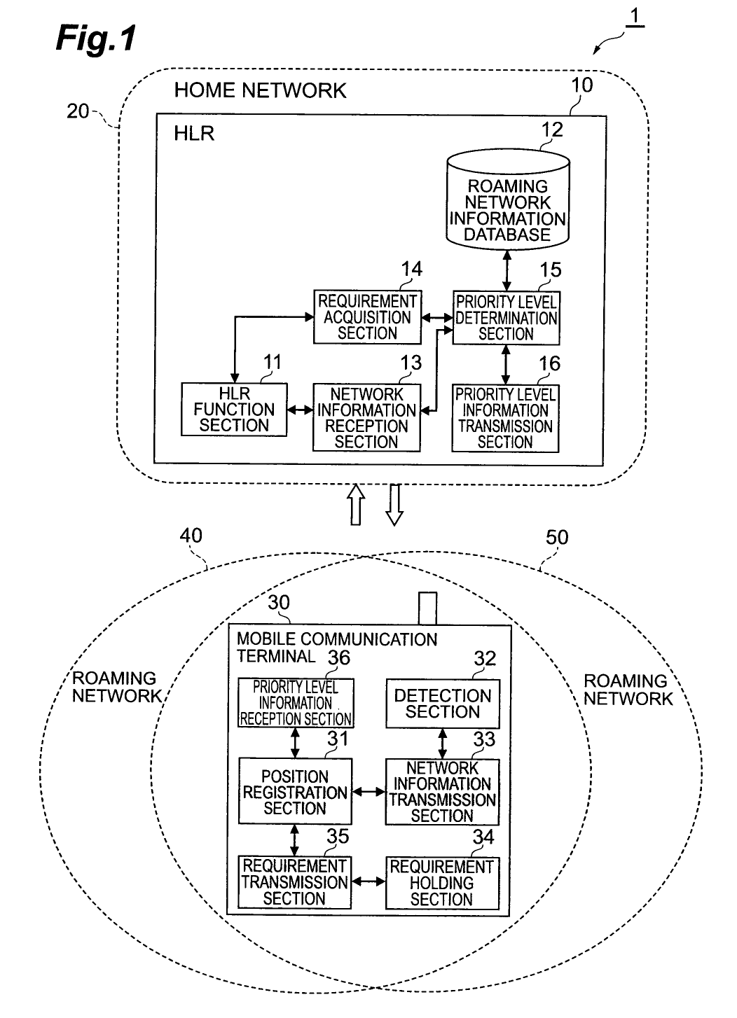

FIG. 1 shows a mobile communication system 1 according to this embodiment. The mobile communication system 1 comprises a mobile communication network 20 that is constituted comprising an HLR (Home Location Register) 10 which is also the roaming control device according to this embodiment and a mobile communication terminal 30 according to this embodiment. The mobile communication network 20 is a network that is provided by the service provider with whom the user of the mobile communication terminal 30 has a contract and the mobile communication terminal 30 is able to perform mobile communications by connecting to the mobile communication network 20 (the mobile communication network 20 is called the ‘home network’ 20 hereinbelow). Further, the mobile communication system 1 comprises mobile communication networks 40 and 50. The mobile communication networks 40 and 50 are networks that support roaming with the mobile communication network 20 and the mobile communication terminal 30 is able to visit the mobile communication networks 40 and 50 for roaming purposes (the mobile communication networks 40 and 50 are called ‘roaming networks’ hereinbelow). Further, although only two roaming networks are drawn in FIG. 1, two or more roaming networks may be contained in the mobile communication system 1. In addition, although not illustrated, the mobile communication networks 20, 40, and 50 comprise a device for providing the mobile communication terminal 30 with a mobile communication function, such as a switching system or base station.

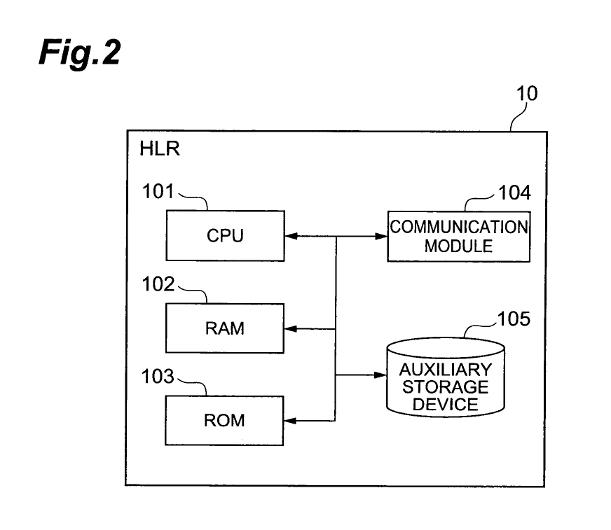

The HLR 10 is a device that manages information relating to the position registration of the mobile communication terminal 30. The HLR 10 is also a roaming control device for controlling the roaming of the mobile communication terminal 30. As shown in FIG. 2, the HLR 10 is constituted as a computer that comprises hardware such as a CPU (Central Processing Unit) 101, a RAM (Random Access Memory) 102 which is a main storage device and a ROM (Read Only Memory) 103, a communication module 104 for performing communications, and an auxiliary storage device 105 such as a hard disk. As a result of the operation of such constituent elements, the original HLR functions and functions of the roaming control device (described subsequently) are demonstrated.

As shown in FIG. 1, the HLR 10 is constituted comprising an HLR function section 11, a roaming network information database 12, a network information reception section 13, a requirement acquisition section 14, a priority level determination section 15, and a priority level information transmission section 16.

The HLR function section 11 constitutes means for managing information relating to registration of the position of the mobile communication terminal 30, which is an original HLR function. In other words, the HLR function section 11 accepts registration of the positional information by receiving a position registration-related signal from the mobile communication terminal 30 and manages the information.

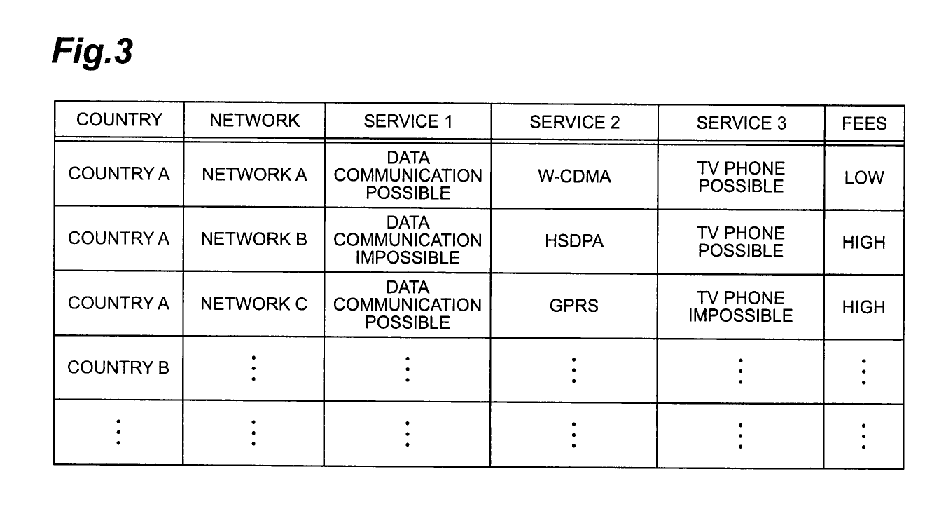

The roaming network information database 12 is a database for storing information relating to the roaming networks 40 and 50. Information relating to the roaming networks 40 and 50 is information on the conditions when using the roaming networks 40 and 50 such as the services and fees of the network, for example. This information is stored specifically in a table of the roaming network information database 12 as shown in FIG. 3. As shown in FIG. 3, the respective information associated with information specifying the roaming networks 40 and 50 (the ‘network’ field in FIG. 3) is stored. The specific content of the information is which country the network service providing area is located in (‘country’ field), whether data communication is possible (‘service 1’ field), the network system (‘service 2’ field), whether a TV phone is possible (‘service 3’ field), and whether the fees are high or low (‘fees’ field) and so forth, for example. The respective information stored in the roaming network information database 12 is preferably always the latest information for receiving the provision of information at regular intervals from the roaming networks 40 and 50, for example.

The network information reception section 13 is network information receiving means for receiving information specifying a plurality of roaming networks 40 and 50 which can be visited by the mobile communication terminal 30, this information being transmitted by the mobile communication terminal 30. The information specifying the roaming networks 40 and 50 is contained in the position registration-related signal as will be described subsequently and, therefore, is acquired from the signal received by the HLR function section 11. In other words, the network information reception section 13 receives information specifying the roaming networks 40 and 50 via the HLR function section 11 from the mobile communication terminal 30. The information specifying the roaming networks 40 and 50 corresponds to information specifying the roaming networks 40 and 50 stored in the roaming network information database 12 so that information stored in the roaming network information database 12 can be referenced. The information specifying the plurality of roaming networks 40 and 50 received by the network information reception section 13 is output to the priority level determination section 15.

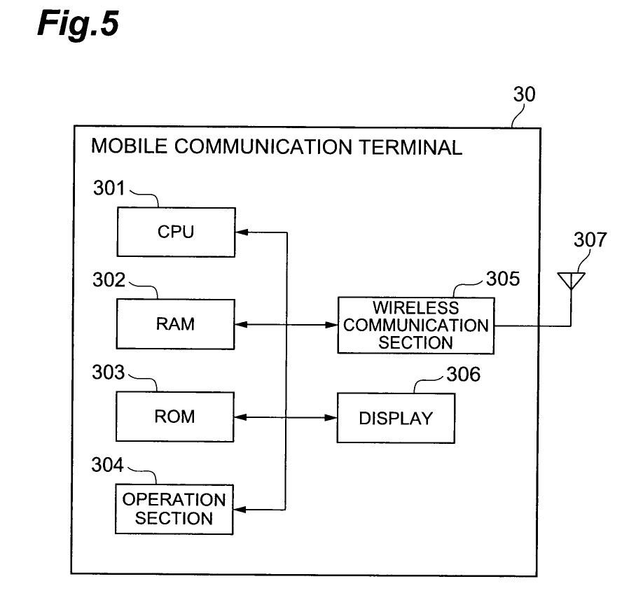

The requirement acquisition section 14 is requirement acquisition means for acquiring information on the requirements with respect to the roaming networks 40 and 50 of the user of the mobile communication terminal 30. The requirements are conditions that are determined when the user is using the roaming networks 40 and 50 such as that ‘fees be low’ and ‘data communication be feasible’, and so forth, for example. Further, the information on the requirements shown in FIG. 5 may be information assigning a priority level to the individual requirements. The information on the requirements is contained in a position-registration-related signal as will be described subsequently and is therefore acquired from the signal received by the HLR function section 11. In other words, the requirement acquisition section 14 receives the information on requirements via the HLR function section 11 from the mobile communication terminal 30. The information on the requirements acquired by the requirement acquisition section 14 is output to the priority level determination section 15.

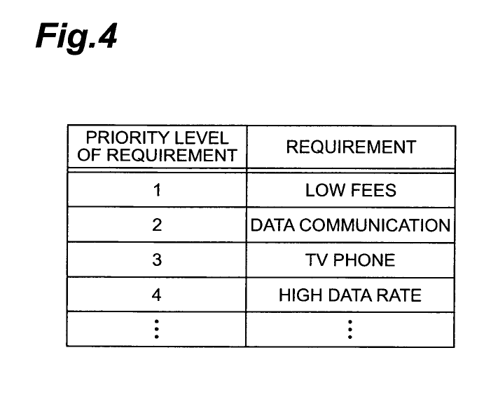

The priority level determination section 15 is priority determination means for determining the priority levels with which the mobile communication terminal 30 is to visit a plurality of roaming networks 40 and 50 specified by the information received by the network information reception section 13. The determination of the priority level is made with reference to the information relating to the roaming networks stored in the roaming network information database 12 on the basis of the requirements acquired by the requirement acquisition section 14. Here, the priority levels are determined such that the priority levels for those roaming networks which satisfy user requirements are high. For example, suppose that a plurality of roaming networks 40 and 50 are “network A” and “network B” in the network shown in FIG. 3 and the requirements are those shown in FIG. 4. Because the requirement with the highest priority level among the requirements is ‘low fees’, it is determined that the priority level of “network A” which has low fees is then high. Further, in cases where the roaming networks 40 and 50 for which the fee condition is the same exist, for example, a judgment is made for ‘data communication is feasible’, which is the next requirement. The priority levels may be determined by ranking the roaming networks 40 and 50, for example, or determined by assigning priority percentage to each of the roaming networks 40 and 50. The information on the priority level thus determined is output to the priority level information transmission section 16.

The priority level information transmission section 16 is priority level information transmission means for transmitting information on the priority level determined by the priority level determination section 15 to the mobile communication terminal 30. The aforementioned priority level information transmission section 16 is a function of the HLR 10 which is the roaming control device according to this embodiment.

The mobile communication terminal 30 is a device for performing mobile communication that specifically corresponds to a cellular phone, for example, and is capable of roaming. FIG. 5 shows the hardware constitution of the mobile communication terminal 30. As shown in FIG. 5, the mobile communication terminal 30 is constituted by hardware such as a CPU 301, a RAM 302, a ROM 303, an operation section 304, a wireless communication section 305, a display 306, and an antenna 307. As a result of the operation of such constituent elements, the respective functions of the mobile communication terminal 30 described hereinbelow are demonstrated.

As shown in FIG. 1, the mobile communication terminal 30 is constituted comprising a position registration section 31, a detection section 32, a network information transmission section 33, a requirement holding section 34, a requirement transmission section 35, and a priority level information reception section 36.

The position registration section 31 is means for performing position registration in which a position-registration-related signal is transmitted to a mobile communication network (to the base station thereof) and a report to the effect that position registration is complete is received from the mobile communication network. Position registration is performed when the mobile communication terminal 30 visits the roaming networks 40 and 50. When there is a plurality of the roaming networks 40 and 50 that can be visited, it is judged whether to perform position registration with respect to either of the roaming networks 40 and 50 on the basis of priority level information for the roaming networks 40 and 50 which is received by the priority level information reception section 36. The position registration section 31 performs position registration with respect to the roaming network with the higher priority level of the two roaming networks 40 and 50. In other words, the position registration section 31 is network-visit processing means for performing processing to visit either of the plurality of roaming networks 40 and 50 on the basis of information on the priority level for the plurality of roaming networks 40 and 50 that is received by the priority level information reception section 36.

The detection section 32 is detection means for detecting a plurality of roaming networks 40 and 50 that can be visited when roaming. The detection of the roaming networks 40 and 50 is performed by receiving report information on the roaming networks 40 and 50, for example. The information specifying the detected roaming networks 40 and 50 is output to the network information transmission section 33.

The network information transmission section 33 is network information transmission means for transmitting the information specifying the plurality of roaming networks 40 and 50 detected by the detection section 32 to the HLR 10. The information specifying the roaming networks is output to the position registration section 31 for the purpose for position registration and contained in a signal that is transmitted to the HLR 10, the transmission of this information specifying the roaming networks being performed together with the transmission of a signal relating to the position registration. In other words, the transmission of the information specifying the roaming networks is performed via the position registration section 31. Further, the HLR 10 is first set as the transmission destination for the information specifying the plurality of roaming networks 40 and 50 detected by the detection section 32.

The requirement holding section 34 is means for holding information on the requirements with respect to the roaming networks 40 and 50 of the user of the mobile communication terminal 30 which is shown in the aforementioned FIG. 4, for example. The information on the requirements is input beforehand by the user using the operation section 304 of the mobile communication terminal 30.

The requirement transmission section 35 is requirement transmission means for reading information on the requirements from the requirement holding section 34 and transmitting the information to the HLR 10. The requirement information is output to the position registration section 31 for the purpose for position registration and contained in a signal that is transmitted to the HLR 10, the transmission of this requirement information being performed together with the transmission of a signal relating to the position registration. In other words, the transmission of the information specifying the requirement information is performed via the position registration section 31. Further, the HLR 10 is set beforehand as the transmission destination for the requirement information.

The priority level information reception section 36 is priority level information reception means for receiving information on the priority level with which its own terminal 30 is to visit the plurality of roaming networks 40 and 50 transmitted by the HLR 10 in accordance with the transmission of information specifying the plurality of roaming networks 40 and 50 performed by the network information transmission section 33. The received priority level information is output to the position registration section 31 and referenced.

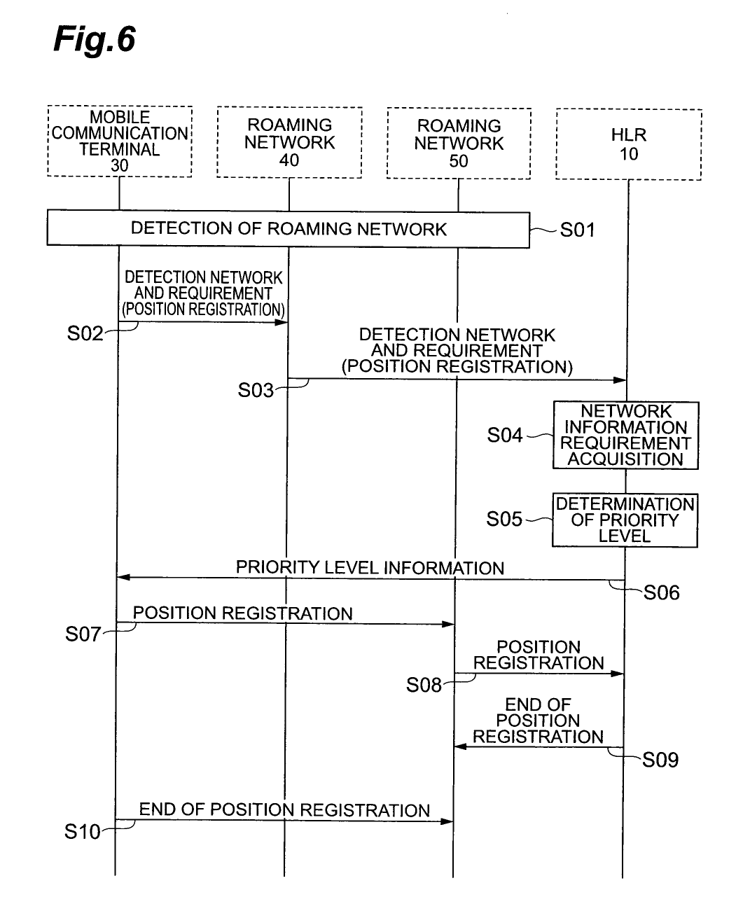

Subsequently, the processing that is executed by the mobile communication system 1 (HLR 10 and mobile communication terminal 30) according to this embodiment (the roaming control method) will be described by using the flowchart in FIG. 6. This processing is performed when the power supply of the mobile communication terminal 30 is turned ON or when the mobile communication network that the mobile communication terminal 30 is visiting is shifted (when it is detected that the currently visited mobile communication network is out of range). In other words, this processing is performed when there is the possibility that new roaming will be performed by the mobile communication terminal 30 and also performed when the information on the requirements of the roaming networks 40 and 50 that is held by the mobile communication terminal 30 (the requirement holding section 34 thereof) is updated. This is because there is a change in the visited roaming networks 40 and 50 according to requirements.

First, the detection section 32 detects two roaming networks 40 and 50 for the mobile communication terminal 30 (S01, detection step). The information specifying the detected roaming networks 40 and 50 is output to the network information transmission section 33 for transmission to the HLR 10. Although there are two roaming networks 40 and 50 detected in this embodiment, there may also be three or more. Further, in cases where the home network 20 is contained within the detected mobile communication network, the visited mobile communication network is then the home network 20 and, therefore, the subsequent processing of the present invention is not executed. In addition, in cases where there is one detected roaming network, the visited mobile communication network is that roaming network. Hence, the subsequent processing of the present invention is not performed.

Thereafter, the position registration section 31 transmits a position-registration-related signal to one roaming network 40 among the plurality of roaming networks. Here, information specifying the roaming networks 40 and 50 detected by the network information transmission section 33 is output to the position registration section 31 and contained in the signal transmitted by the position registration section 31. In addition, information on the requirements is output by the requirement transmission section 35 to the position registration section 31 and contained in the signal that is transmitted by the position registration section 31 (S02, network information transmission step, requirement transmission step). Further, in cases where the mobile communication terminal 30 has been set to the manual search mode, the user's purpose is respected and, because the mobile communication terminal 30 visits the manually selected roaming network 40, 50, the information specifying the detected roaming networks 40, 50 is not transmitted and conventional position registration processing is executed.

Here, the roaming network to which the position-registration-related signal is transmitted is selected in accordance with the specifications. Alternatively, here, the priority sequence for the roaming networks to which the signal is transmitted may be pre-prepared and a selection made in accordance with this priority sequence. If the priority sequence is suitably prepared, because the probability of performing position registration with respect to the roaming network which is the highest-priority destination also according to the priority levels determined by the HLR 10 is high, the probability of re-executing position registration processing is low as will be described subsequently. As a result, the number of signals required for the position registration can be reduced.

Thereafter, the roaming network 40 which receives the position-registration-related signal from the mobile communication terminal 30 transmits this signal to the HLR 10 (S03). The position-registration-related signal thus transmitted is received by the HLR function section 11 in the HLR 10.

In the HLR 10, the network information reception section 13 acquires information specifying the roaming networks 40 and 50 from the signal received by the HLR function section 11. Further, the requirement acquisition section 14 acquires information on the requirements with respect to the roaming networks 40 and 50 of the user of the mobile communication terminal 30 from the signal received by the HLR function section 11 (S04, network information reception step, requirement acquisition step). The respective information received is output to the priority level determination section 15.

Thereafter, the priority level determination section 15 determines the priority level with which the mobile communication terminal 30 is to visit the plurality of roaming networks 40 and 50 (S05, priority level determination step). The information on the priority level is output to the priority level information transmission section 16 and transmitted from the priority level information transmission section 16 to the mobile communication terminal 30. The priority level information reception section 36 in the mobile communication terminal 30 receives this information (S06, priority level information transmission step, priority level information reception step). In this embodiment, the roaming network with the higher priority among the two roaming networks 40 and 50 is assumed to be the roaming network 50 (a roaming network that differs from the roaming network 40 which is the transmission destination of the position-registration-related signal in S02).

Here, in cases where the roaming network with the highest priority is the roaming network 40 which is the transmission destination of the position-registration-related signal in S02, because there is then no need to perform position registration once again from the mobile communication terminal 30, the HLR 10 performs position information registration for the transmission of a position-registration-related signal in S02 and issues a notice regarding the completion of position registration.

After receiving priority level information, information on the priority level that is received by the position registration section 31 from the priority level information reception section 36 is output by the mobile communication terminal 30. The position registration section 31 performs processing to visit the roaming network on the basis of the priority level information. In this embodiment, the position registration section 31 performs processing for position registration with respect to the roaming network 50 with the higher priority level. More specifically, the position registration section 31 transmits a position-registration-related signal to the roaming network 50 (S07, network-visit processing step). The roaming network 50, to which the position-registration-related signal is transmitted, transmits the position-registration-related signal to the HLR 10 (S08) and receives a notice regarding the completion of position registration that is transmitted by the HLR 10 in response to this transmission (S09). Thereafter, the position registration section 31 receives the notice regarding the completion of position registration that is transmitted by the roaming network 50 and the processing for a network visit is complete (S10, network-visit processing step).

Further, in cases where position registration is rejected by the roaming network 50 to which the position-registration-related signal is transmitted in S07, the position registration section 31 implements position registration with respect to the roaming network with the next highest priority level. So too thereafter, in cases where position registration is rejected, position registration is attempted in accordance with the priority level.

As mentioned hereinabove, according to this embodiment, if the user designates the requirements with respect to the roaming networks 40 and 50 of the mobile communication terminal 30, the user is able to automatically afford the mobile communication terminal 30 visit to the roaming network 40, 50 conforming to these requirements without examining the conditions and so forth of the roaming networks 40 and 50 ahead of time. Further, as long as an attempt is made to always store the latest information in the roaming network information database 12 of the HLR 10, it will be possible to reliably visit the roaming networks 40 and 50 conforming to requirements. Further, according to this embodiment, because the user is not required to set the priority levels for the individual roaming networks 40 and 50, even in cases where the user has not identified the individual roaming networks 40 and 50, the mobile communication terminal 30 is able to visit the suitable roaming network 40, 50.

Furthermore, as per this embodiment, assuming that requirement information is transmitted by the mobile communication terminal 30 and used in the determination of priority level upon receipt by the HLR 10, requirement information can be reliably acquired by the HLR 10 and the present invention can be reliably implemented.

However, the requirement information is not necessarily sent and received in the processing during roaming as per this embodiment and may instead be pre-registered in the HLR 10 which is the roaming control device according to this embodiment. The registered requirement information is stored in association with information specifying the mobile communication terminal 30 and the requirement acquisition section 14 judges that it is possible to distinguish which requirement information is for which user upon acquisition of the requirement information. Registration-related information may also be transmitted beforehand by the mobile communication terminal 30 and information transmitted via the Internet may also be used. In addition, the requirement information may be communicated to the operator of the HLR 10 via paperwork or FAX and registered by hand.

The roaming control device according to this embodiment is integrated with the HLR but there is not necessarily a requirement for such a constitution. The roaming control device may also be a device with a constitution that is independent from that of the HLR. The roaming control device may also be integrated with another device contained in the home network 20.

What is claimed is:

1. A roaming control device, comprising:
a roaming network information database for storing information relating to roaming networks that are mobile communication networks which a mobile communication terminal is able to visit during roaming;
network information reception means for receiving information transmitted by the mobile communication terminal and specifying a plurality of roaming networks that can be visited by the mobile communication terminal;
requirement acquisition means for acquiring information on the requirements of a user of the mobile communication terminal with respect to the roaming networks;
priority level determination means for determining the priority level with which the mobile communication terminal is to visit the plurality of roaming networks specified by information that is received by the network information reception means by referencing information relating to the roaming networks stored in the roaming network information database on the basis of the requirements acquired by the requirement acquisition means; and
priority level information transmission means for transmitting information on the priority level determined by the priority level determination means to the mobile communication terminal.

2. The roaming control device according to claim 1, wherein the requirement acquisition means acquires the information on the requirements by receiving same from the mobile communication terminal.

3. The roaming control device according to claim 1, wherein the requirement acquisition means performs acquisition from information on the requirements that is pre-registered.

4. A mobile communication terminal, comprising:
detection means for detecting a plurality of roaming networks which are a plurality of mobile communication networks that can be visited during roaming;
network information transmission means for transmitting information specifying the plurality of roaming networks detected by the detection means to a roaming control device;
priority level information reception means for receiving information on the priority level with which its own terminal is to visit the plurality of roaming networks, that is transmitted by the roaming control device in response to the transmission of information specifying the plurality of roaming networks that is carried out by the network information transmission means; and
network-visit processing means for performing processing to visit any of the plurality of roaming networks on the basis of information on the priority level for the plurality of roaming networks that is received by the priority level information reception means.

5. The mobile communication terminal according to claim 4, further comprising:
requirement transmission means for transmitting information on the requirements of a user with respect to the roaming networks, to the roaming control device.

6. The mobile communication terminal according to claim 5, wherein the requirement transmission means transmits information on the requirements by including the information on the requirements in a position-registration-related signal that is transmitted by the mobile communication terminal.

7. A mobile communication system that is constituted comprising a roaming control device and a mobile communication terminal, wherein the roaming control device comprises:
a roaming network information database for storing information relating to roaming networks that are mobile communication networks which the mobile communication terminal is able to visit during roaming;
network information reception means for receiving information transmitted by the mobile communication terminal and specifying a plurality of roaming networks that can be visited by the mobile communication terminal;
requirement acquisition means for acquiring information on the requirements of a user of the mobile communication terminal with respect to the roaming networks;
priority level determination means for determining the priority level with which the mobile communication terminal is to visit the plurality of roaming networks specified by information that is received by the network information reception means by referencing information relating to the roaming networks stored in the roaming network information database on the basis of the requirements acquired by the requirement acquisition means; and
priority level information transmission means for transmitting information on the priority level determined by the priority level determination means to the mobile communication terminal,
and wherein the mobile communication terminal comprises:
detection means for detecting the plurality of roaming networks;
network information transmission means for transmitting information specifying the plurality of roaming networks detected by the detection means to the roaming control device;
priority level information reception means for receiving information on the priority level with which its own terminal is to visit the plurality of roaming networks, that is transmitted by the roaming control device in response to the transmission of information specifying the plurality of roaming networks that is carried out by the network information transmission means; and
network-visit processing means for performing processing to visit any of the plurality of roaming networks on the basis of information on the priority level for the plurality of roaming networks that is received by the priority level information reception means.

8. A roaming control method for a roaming control device comprising a roaming network information database that stores information relating to roaming networks which are mobile communication networks that the mobile communication terminal is able to visit during roaming, comprising:
a network information reception step of receiving information transmitted by the mobile communication terminal and specifying a plurality of roaming networks that can be visited by the mobile communication terminal;
a requirement acquisition step of acquiring information on the requirements of a user of the mobile communication terminal with respect to the roaming networks;
a priority level determination step of determining the priority level with which the mobile communication terminal is to visit the plurality of roaming networks specified by information that is received in the network information reception step by referencing information relating to the roaming networks stored in the roaming network information database on the basis of the requirements acquired in the requirement acquisition step; and
a priority level information transmission step of transmitting information on the priority level determined in the priority level determination step to the mobile communication terminal.

9. A roaming control method for a mobile communication terminal, comprising:
a detection step of detecting a plurality of roaming networks which are a plurality of mobile communication networks that can be visited during roaming;
a network information transmission step of transmitting information specifying the plurality of roaming networks detected in the detection step to a roaming control device;
a priority level information reception step of receiving information on the priority level with which its own terminal is to visit the plurality of roaming networks, that is transmitted by the roaming control device in response to the transmission of information specifying the plurality of roaming networks that is carried out in the network information transmission step; and
a network-visit processing step of performing processing to visit any of the plurality of roaming networks on the basis of information on the priority level for the plurality of roaming networks that is received in the priority level information reception step.

10. A roaming control method for a mobile communication system constituted having a mobile communication terminal and a roaming control device, which comprises a roaming network information database that stores information relating to roaming networks which are mobile communication networks that the mobile communication terminal is able to visit during roaming, comprising:
a network information reception step in which the roaming control device receives information transmitted by the mobile communication terminal and specifying a plurality of roaming networks that can be visited by the mobile communication terminal;
a requirement acquisition step in which the roaming control device acquires information on the requirements of a user of the mobile communication terminal with respect to the roaming networks;
a priority level determination step in which the roaming control device determines the priority level with which the mobile communication terminal is to visit the plurality of roaming networks specified by information that is received in the network information reception step by referencing information relating to the roaming networks stored in the roaming network information database on the basis of the requirements acquired in the requirement acquisition step; and
a priority level information transmission step in which the roaming control device transmits information on the priority level determined in the priority level determination step to the mobile communication terminal, and further comprising:
a detection step in which the mobile communication terminal detects the plurality of roaming networks;
a network information transmission step in which the mobile communication terminal transmits information specifying the plurality of roaming networks detected in the detection step to the roaming control device;
a priority level information reception step in which the mobile communication terminal receives information on the priority level with which its own terminal is to visit the plurality of roaming networks, that is transmitted by the roaming control device in response to the transmission of information specifying the plurality of roaming networks that is carried out in the network information transmission step; and
a network-visit processing step in which the mobile communication terminal performs processing to visit any of the plurality of roaming networks on the basis of information on the priority level for the plurality of roaming networks that is received in the priority level information reception step.
